(19) United States
(12) Patent Application Publication
(10) Pub. No.: US 2026/0156136 A1
(43) Pub. Date: Jun. 4, 2026

(54) NETWORK ASSET MATCHING ACROSS NETWORK PENETRATION TESTS

(71) Applicant: Horizon 3 AI, Inc., Dover, DE (US)

(72) Inventors: Robert George Alderman, Lafayette, CO (US); Levi Dyrek Payne, Woodlawn, VA (US); Chad Glinsky, Boulder, CO (US); John Esser Dodson, New York, NY (US); Hanjing Cao, New York, NY (US)

(21) Appl. No.: 19/170,039

(22) Filed: Apr. 3, 2025

Related U.S. Application Data
(63) Continuation-in-part of application No. 18/968,550, filed on Dec. 4, 2024.

(51) Int. Cl. H04L 9/40; H04L 41/16; H04L 43/065

(52) U.S. Cl. CPC H04L 63/1433; H04L 41/16; H04L 43/065

(57) ABSTRACT

An autonomous pentesting agent may execute multiple autonomous pentests to gain access to network assets and obtain sets of attributes of the network assets and match network assets across the multiple autonomous pentests according to similarities between the sets of attributes. The autonomous pentesting agent may perform a network asset matching procedure to match one or more first network assets of a first set of network assets with one or more second network assets of a second set of network assets, the network asset matching procedure based on similarity scores between respective first sets of attributes of the first set of network assets and respective second sets of attributes of the second set of network assets. The autonomous pentesting agent may output a network assessment report indicating network security information associated with the network based on the network asset matching procedure.

### CROSS-REFERENCE

This application is a continuation-in-part of U.S. patent application Ser. No. 18/968,550, filed Dec. 4, 2024, entitled “NETWORK ASSET MATCHING ACROSS NETWORK PENETRATION TESTS,” which is incorporated herein by reference.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support network asset matching across network pentests.

A method for network asset matching by an apparatus is described. The method may include executing a first autonomous pentest of a network, wherein executing the first autonomous pentest may include operations, features, means, or instructions for gaining unauthorized access to a first set of network assets of the network and obtaining respective first sets of attributes for the first set of network assets, executing a second autonomous pentest of the network, wherein executing the second autonomous pentest may include operations, features, means, or instructions for gaining unauthorized access to a second set of network assets of the network and obtaining respective second sets of attributes for the second set of network assets, performing a network asset matching procedure to match one or more first network assets of the first set of network assets with one or more second network assets of the second set of network assets, the network asset matching procedure based at least in part on similarity scores between the respective first sets of attributes and the respective second sets of attributes, applying a first label associated with a first network asset of the one or more first network assets to a second network asset of the one or more second network assets based at least in part on a match between the first network asset and the second network asset via the network asset matching procedure, and outputting a network assessment report indicating network security information associated with the network based at least in part on the network asset matching procedure and applying the first label associated with the first network asset to the second network asset.

An apparatus for network asset matching is described. The apparatus may include one or more memories storing processor executable code, and one or more processors coupled with the one or more memories. The one or more processors may individually or collectively be operable to execute the code to cause the apparatus to execute a first autonomous pentest of a network, wherein, to execute the first autonomous pentest, the one or more processors are individually or collectively operable to execute the code to cause the apparatus to gain unauthorized access to a first set of network assets of the network and obtain respective first sets of attributes for the first set of network assets, execute a second autonomous pentest of the network, wherein, to execute the second autonomous pentest, the one or more processors are individually or collectively operable to execute the code to cause the apparatus to gain unauthorized access to a second set of network assets of the network and obtain respective second sets of attributes for the second set of network assets, perform a network asset matching procedure to match one or more first network assets of the first set of network assets with one or more second network assets of the second set of network assets, the network asset matching procedure based at least in part on similarity scores between the respective first sets of attributes and the respective second sets of attributes, apply a first label associated with a first network asset of the one or more first network assets to a second network asset of the one or more second network assets based at least in part on a match between the first network asset and the second network asset via the network asset matching procedure, and output a network assessment report indicating network security information associated with the network based at least in part on the network asset matching procedure and applying the first label associated with the first network asset to the second network asset.

Another apparatus for network asset matching is described. The apparatus may include means for executing a first autonomous pentest of a network, wherein the means for executing the first autonomous pentest comprise means for gaining unauthorized access to a first set of network assets of the network and means for obtaining respective first sets of attributes for the first set of network assets, means for executing a second autonomous pentest of the network, wherein the means for executing the second autonomous pentest comprise means for gaining unauthorized access to a second set of network assets of the network and means for obtaining respective second sets of attributes for the second set of network assets, means for performing a network asset matching procedure to match one or more first network assets of the first set of network assets with one or more second network assets of the second set of network assets, the network asset matching procedure based at least in part on similarity scores between the respective first sets of attributes and the respective second sets of attributes, means for applying a first label associated with a first network asset of the one or more first network assets to a second network asset of the one or more second network assets based at least in part on a match between the first network asset and the second network asset via the network asset matching procedure, and means for outputting a network assessment report indicating network security information associated with the network based at least in part on the network asset matching procedure and applying the first label associated with the first network asset to the second network asset.

A non-transitory computer-readable medium storing code for network asset matching is described. The code may include instructions executable by one or more processors to execute a first autonomous pentest of a network, wherein the instructions to execute the first autonomous pentest are executable to gain unauthorized access to a first set of network assets of the network and obtain respective first sets of attributes for the first set of network assets, execute a second autonomous pentest of the network, wherein the instructions to execute the second autonomous pentest are executable to gain unauthorized access to a second set of network assets of the network and obtain respective second sets of attributes for the second set of network assets, perform a network asset matching procedure to match one or more first network assets of the first set of network assets with one or more second network assets of the second set of network assets, the network asset matching procedure based at least in part on similarity scores between the respective first sets of attributes and the respective second sets of attributes, apply a first label associated with a first network asset of the one or more first network assets to a second network asset of the one or more second network assets based at least in part on a match between the first network asset and the second network asset via the network asset matching procedure, and output a network assessment report indicating network security information associated with the network based at least in part on the network asset matching procedure and applying the first label associated with the first network asset to the second network asset.

### BRIEF DESCRIPTION OF THE DRAWINGS

FIG. 1 shows an example of a computing environment that supports network asset matching across network pentests in accordance with aspects of the present disclosure.

FIG. 2 shows an example of an autonomous pentest map that supports network asset matching across network pentests in accordance with aspects of the present disclosure.

FIG. 3 shows an example of a computing environment that supports network asset matching across network pentests in accordance with aspects of the present disclosure.

FIG. 4 shows an example of a network asset matching procedure that supports network asset matching across network pentests in accordance with aspects of the present disclosure.

FIG. 5 shows an example of a similarity scoring that supports network asset matching across network pentests in accordance with aspects of the present disclosure.

FIG. 6 shows an example of an asset matching matrix that supports network asset matching across network pentests in accordance with aspects of the present disclosure.

FIG. 7 shows a diagram of a system including a device that supports network asset matching across network pentests in accordance with aspects of the present disclosure.

FIG. 8 shows a flowchart illustrating methods that support network asset matching across network pentests in accordance with aspects of the present disclosure.

### DETAILED DESCRIPTION

A pentesting agent may perform a pentest of a network that includes multiple network assets. The pentest may identify weaknesses and vulnerabilities of the network by attempting to gain unauthorized access to various network assets. Based on the weaknesses and vulnerabilities identified during the pentest, security mitigations may be applied to the network. For example, an administrator of the network or a security service may deploy security solutions to or within the network to address weaknesses and vulnerabilities identified by an initial pentest. In some cases, the pentesting agent may perform an additional pentest of the network to evaluate whether the security mitigations or solutions that were applied after the initial pentest have been effective (e.g., whether the security mitigations or solutions blocked unauthorized access to the network assets or addressed vulnerabilities identified by the initial pentest). That is, the pentesting agent may perform the additional pentest after the security mitigations are applied, and weaknesses and vulnerabilities identified during the additional pentest may be compared to the initial pentest. However, in some cases, aspects of the network may change between the initial pentest and the additional pentest. For example, the initial pentest may identify a network asset having attributes such as a host name, a media access control (MAC) address, or the like. In the additional pentest, the pentesting agent may identify the same network asset, but one or more of the attributes may be different (e.g., the network asset identified in the additional pentest may have a same host name but a different MAC address). In such cases, the pentesting agent may be unable to classify the network asset identified in the additional pentest as being the same network asset as that which was identified in the initial pentest due to the change in attributes. Additionally, when evaluating the results of the additional pentest (or one or more subsequent pentests), the administrator or the security service may be unable to determine whether the deployed security mitigations were effective. Accordingly, techniques described herein support matching of network assets across network pentests such that security mitigations deployed between pentests may be accurately evaluated.

An autonomous pentesting agent may perform multiple autonomous pentests and match network assets across the autonomous pentests. For example, the autonomous pentesting agent may perform the initial pentest and identify network vulnerabilities. A client (e.g., the administrator, the security service, etc.) may implement security solutions to address the identified network vulnerabilities. After the security solutions are implemented, the autonomous pentesting agent may perform an additional pentest (e.g., on the same network) to verify the efficacy of the security solutions. As attributes of network assets may change between the initial pentest and the additional pentest, the autonomous pentesting agent may perform a network asset matching procedure to match network assets across the pentests based on similarity scores between the network assets identified during the initial pentest and the additional pentest.

For example, the autonomous pentesting agent may, during a first autonomous pentest, gain unauthorized access to first network assets of a network and obtain attributes for each of the first network assets. The autonomous pentesting agent may then execute a second, subsequent autonomous pentest, during which the autonomous pentesting agent may gain unauthorized access to access to second network assets of the network and obtain attributes for each of the second network assets. The autonomous pentesting agent may determine similarity scores between each network asset of the first network assets and each network asset of the second network assets. Based on the similarity scores, the autonomous pentesting agent may match one or more network assets from the first network assets with one or more network assets from the second network assets and output a network assessment report indicating network security information associated with the network based on the matches. For example, the network assessment report may identify or include changes in the network, such as changes in security vulnerabilities, between the first autonomous pentest and the second autonomous pentest.

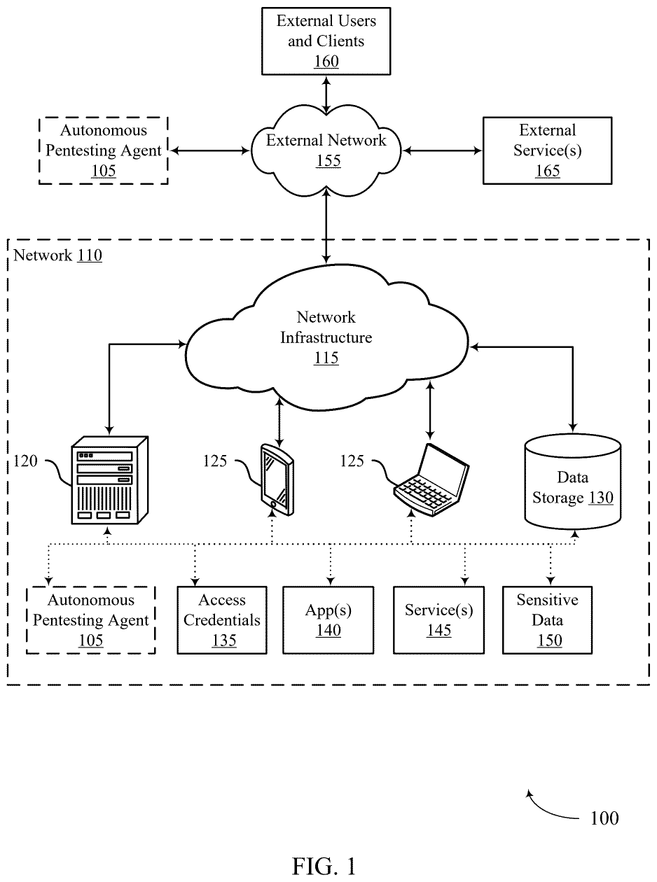

FIG. 1 illustrates an example of a computing environment 100 that supports network asset matching across network pentests in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein network assets refer to data, devices, or components of the network 110, including software and hardware. In some examples, network assets may refer to machines that include network shares. For example, network assets may be examples of machines (e.g., real or virtual machines) that include shares of the network 110, such as file sharing systems. Network assets may be obtained and utilized by attackers to compromise the network 110. In some cases, network assets may refer to network entities (i.e., system hosts/machines) that have internet protocol (IP) addresses and may be discovered during scans. The server 120, the computing devices 125 (e.g., laptops, desktops, and mobile devices, smart vehicles, wearables, etc.), the data storage 130, and the access credentials 135, app(s) 140, service(s) 145, cookies, encryption and decryption keys, tokens, and sensitive data 150 accessible via the devices and systems of the network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

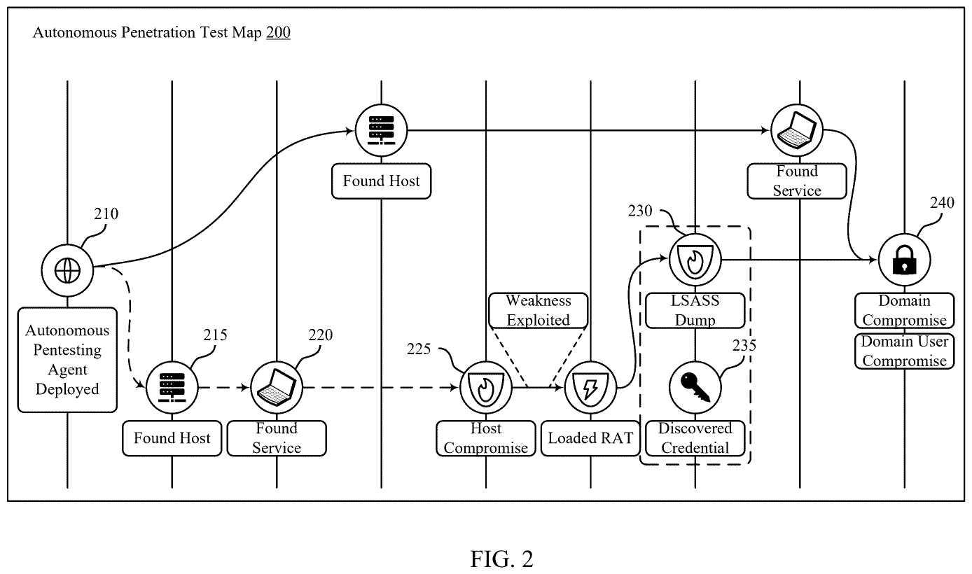

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more artificial intelligence (AI) models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155. In some examples, the autonomous pentesting agent 105 may be deployed via a runner. For example, a runner may be an executable process, script, or sequence, that enables automated deployment of a container (e.g., a Docker container, such as a Docker container running as a Kubernetes pod). A container may refer to an executable package of software including code, runtime, system tools, system libraries, settings, and other components to run an application. The runner and the container may allow a user to provision and deploy pentests from a portal without manually running a launch script for the autonomous pentesting agent 105.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

As described herein, the autonomous pentesting agent 105 may match network assets of the network 110 across different autonomous pentests. Matching the network assets across autonomous pentests may enable the autonomous pentesting agent 105 to accurately report changes to the network 110 between pentests (e.g., such as between two or more pentests run (e.g., periodically) on a network over a period of time). For example, a client may implement security solutions in the network 110 (e.g., at the server 120, computing devices 125, app(s) 140, service(s) 145, etc.) and request that the autonomous pentesting agent 105 perform an additional autonomous pentest to evaluate the implemented security solutions. That is, the autonomous pentesting agent 105 may perform a second autonomous pentest of the network 110 and identify whether the security solutions are effective in mitigating one or more security vulnerabilities. To determine whether the security solutions are effective, the autonomous pentesting agent 105 may match network assets accessed during the first autonomous pentest with network assets accessed during the second autonomous pentest. In other words, the autonomous pentesting agent 105 may determine whether a network asset from the first autonomous pentest is the same as a network asset from the second autonomous pentest based on attributes obtained or identified across the first and second autonomous pentests.

By supporting network asset matching across pentests, techniques described herein may improve accuracy of network assessment reporting. For example, the autonomous pentesting agent 105 may identify changes between a first autonomous pentest and a second autonomous pentest, including absences of security vulnerabilities or weaknesses, whether a same network asset was accessed in each pentest, security vulnerabilities or weaknesses introduced due to a change in the network, or the like. By accurately identifying the changes in the network 110, techniques described herein may support improved network security. Additionally, by autonomously matching network assets across pentests, techniques described herein may reduce resource overhead and computational complexity associated with manually labeling network assets or manually identifying whether network assets are the same across autonomous pentests.

FIG. 2 shows an example of an autonomous pentest map 200 that supports network asset matching across network pentests in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support network asset matching across network pentests. For example, the autonomous pentesting service may provide a network assessment report that indicates changes to the network between a first autonomous pentest (e.g., an initial pentest) and a second autonomous pentest (e.g., a subsequent pentest). The autonomous pentesting service may identify changes to the network according to the autonomous pentest map 200. For example, the autonomous pentesting service may identify that a security vulnerability at a network asset in the first autonomous pentest is absent in the second autonomous pentest. Additionally, or alternatively, the autonomous pentesting service may identify a new security vulnerability at a network asset in the second autonomous pentest that was absent in the first autonomous pentest. The autonomous pentesting service may support identification of changes to the network by identifying whether network assets accessed during different autonomous pentests are the same network asset (e.g., by performing network asset matching).

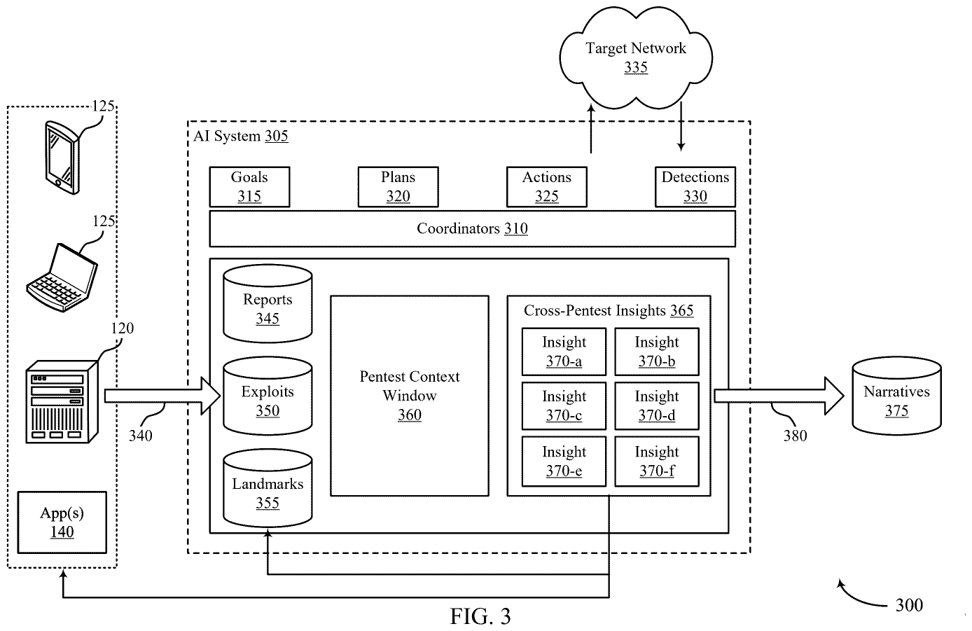

FIG. 3 shows an example of a computing environment 300 that supports network asset matching across network pentests in accordance with aspects of the present disclosure. The computing environment 300 may implement or be implemented by the computing environment 100, the autonomous pentest map 200, or both. For example, the computing environment 300 may illustrate servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions. In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously, at least for some operations, to achieve specified goals, make decisions, and take actions without direct human intervention (e.g., through the use of AI agents). In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a network 110, compromise (such as by obtain unauthorized administrative access or deploying unauthorized software to) a domain or a network asset of the network 110, or any combination thereof. To obtain the goals 315, the AI system 305 may generate one or more plans 320 that are based on actions 325 and detections 330. For example, to determine a next best action within a defined set of guardrails or instructions, the AI system 305 may generate a plan 320 that can include an action 325 to invoke (e.g., execute) one or more commands on a target network 335 to obtain a detection 330 from the target network 335.

In some examples, the target network may include one or more network assets such as servers 120, computing devices 125, data storages 130, app(s) 140, or any combination thereof. Further, obtaining a detection 330 from the target network 335 may include the AI system 305 retrieving telemetry data from the one or more network assets of the target network 335. In some cases, telemetry data obtained from the target network 335 may include logs, traces, metrics, events, or any combination thereof from the one or more network assets of the target network 335. For example, a detection 330 may include some data that is obtained from the target network 335 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 335, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, or billions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 thar resulted in the action 325 succeeding or failing, or any combination thereof. Therefore, the AI system 305 may continuously obtain and update the training data used for training AI/ML models and perform reinforcement learning using collective intelligent to improve the weights and training of the AI/ML models.

In some examples, the training data for the AI system 305 may include telemetry data obtained from the target network 335, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 335) to assist the AI system 305 to navigate and map a target environment during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by proving the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 335, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentests, including successfully exploited vulnerabilities, accessed systems and data, attempted but failed exploit paths, among others.

In some examples, the AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in commonly used enterprise software. In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant network compromise. Therefore, the cross-pentest insights 365 may indicate one or more insights 370 that represent patterns and vulnerabilities that occur across different networks and testing scenarios, helping organizations better understand systemic security weaknesses that need to be addressed. For example, the cross-pentest insights 365 may be added as landmarks 355 for further training the AI system 305 to perform autonomous pentests.

In some examples, the cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a network 110. In another example, a narrative 375 may be a presentation for a company or organization that indicates the one or more vulnerabilities in a network 110 associated with the company or organization. For example, the presentation can indicate the cross-pentest insights 365 obtained from performing one or more autonomous pentests on the network 110 associated with the company or organization (e.g., the target network 335).

The AI system 305 may perform one or more operations described herein to match network assets of the network 110 across different autonomous pentests. Accordingly, the AI system 305 may support identification of changes between a first autonomous pentest and a second autonomous pentest, including absences of security vulnerabilities or weaknesses, whether a same network asset was accessed in each pentest, security vulnerabilities or weaknesses introduced due to a change in the network, or the like. By accurately identifying the changes in the network 110, techniques described herein may support improved network security. Additionally, by matching network assets across pentests using the AI system 305 (e.g., autonomously), techniques described herein may reduce resource overhead and computational complexity associated with manually labeling network assets or manually identifying whether network assets are the same across autonomous pentests.

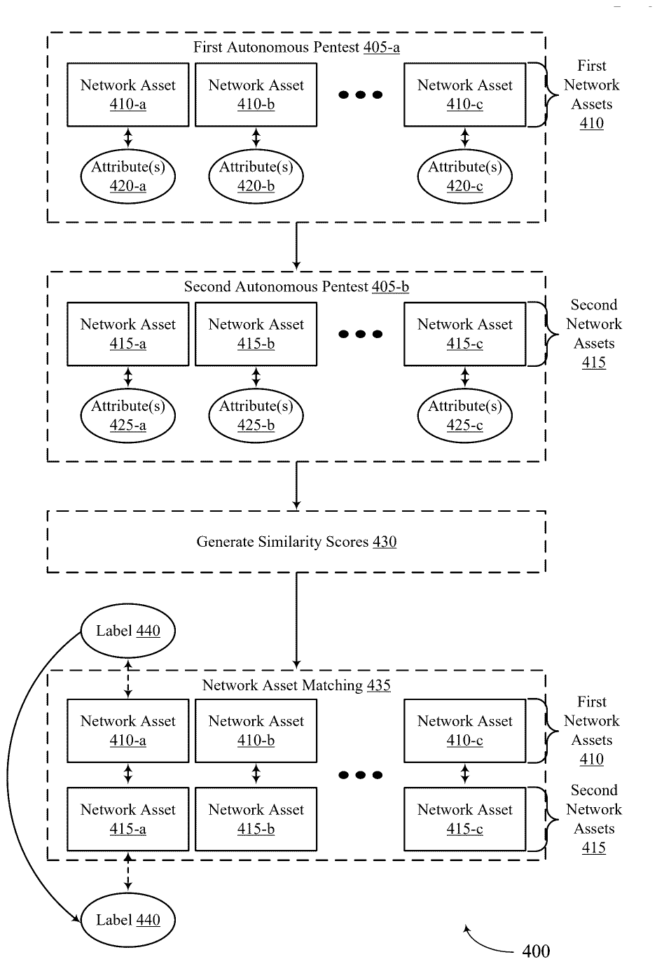

FIG. 4 shows an example of a network asset matching procedure 400 that supports network asset matching across network pentests in accordance with aspects of the present disclosure. The network asset matching procedure 400 may implement or be implemented by the computing environment 100, the autonomous pentest map 200, the computing environment 300, or any combination thereof. For example, the network asset matching procedure 400 may include first network assets 410 and second network assets 415, which may be examples of the network assets described with reference to FIG. 1. Additionally, the network asset matching procedure 400 may illustrate matching of first network assets 410 to second network assets 415 that are identified during different autonomous pentests of a network, such as the network 110 described with reference to FIG. 1. The autonomous pentesting agent 105 described with reference to FIG. 1 may perform one or more operations of the network asset matching procedure 400.

An autonomous pentesting agent may perform a first autonomous pentest 405-a. The first autonomous pentest 405-a may include gaining unauthorized access to first network assets 410, including a network asset 410-a, a network asset 410-b, and a network asset 410-b. Additionally, the first autonomous pentest 405-a may include obtaining attributes of each of the first network assets 410. For example, the first autonomous pentest 405-a may include obtaining attribute(s) 420-a of the network asset 410-a, attribute(s) 420-b of the network asset 410-b, and attribute(s) 420-c of the network asset 410-c. In some examples, the autonomous pentesting agent may report results of the first autonomous pentest 405-a. For example, the autonomous pentesting agent may output a report indicating the assets that were accessed, how access was gained, vulnerabilities and weaknesses of the network, or the like. In some examples, the report may include recommendations for security solutions to the identified vulnerabilities and weaknesses.

After the first autonomous pentest 405-a, the autonomous pentesting agent may perform a second autonomous pentest 405-b. The second autonomous pentest 405-b may include gaining unauthorized access to second network assets 415, including a network asset 415-a, a network asset 415-b, and a network asset 415-b. Additionally, the second autonomous pentest 405-b may include obtaining attributes of each of the second network assets 415. For example, the second autonomous pentest 405-b may include obtaining attribute(s) 425-a of the network asset 415-a, attribute(s) 425-b of the network asset 415-b, and attribute(s) 425-c of the network asset 415-c. While three network assets are shown as being accessed during each of the autonomous pentests described with reference to FIG. 4, it may be understood that any quantity of network assets may be accessed by the autonomous pentest agent during the autonomous pentests.

The first network assets 410 and the second network assets 415 may be examples of network assets described with reference to FIG. 1. In some examples, the first network assets 410, the second network assets 415, or both may include hosts. The autonomous pentesting agent may classify the network assets into asset types (e.g., hosts, databases, computing devices, app(s), services, etc.) during network asset matching 435. In some examples, a network asset may include a group of hosts (e.g., one or more hosts) identified across autonomous pentests that the autonomous pentesting agent identified as a single network asset.

The attribute(s) of each network asset of the first network assets 410 and the second network assets 415 may include a domain name system (DNS) hostname, a hostname, a network basic input/output system (NetBIOS) name, a media access control (MAC) address, an internet protocol (IP) address, machine identifier, a virtual host, virtual machine identifier(s), device fingerprint(s), hardware fingerprint(s), a subnet, a lightweight directory access protocol (LDAP) host name, elastic compute cloud instance identifier (e.g., an Amazon EC2 instance ID), a resource identifier associated with cloud assets (e.g., an Amazon resource name (ARN)), a set of services, open ports, certificate name(s), secure sockets layer (SSL) certificate(s), a set of fileshares, a set of applications (e.g., associated with or accessible via the network asset), application data, operating system(s) (OSs) (e.g., OS name(s)), flags (e.g., indicating a domain controller), pentest configuration attributes, Kubernetes metadata (e.g., data that helps uniquely identify an object, including a name string, a unique identifier (UID), and optional namespace), or any combination thereof. The application data may be for web applications or applications run locally (e.g., on an internal server). For web applications, the application data may include web data such as response headers, cookies, similarity hash(es), a hash of a website provided by the network asset, or the like. Additionally, or alternatively, the pentest configuration attributes may include an identifier of the network that the autonomous pentest agent ran on, a scope of the autonomous pentest (e.g., of the entire network, of a subset of the network, of a group of network assets, etc.), runners indicating where the autonomous pentest was launched from, a launchpoint of the pentest, a pentest operation template, an indication of whether the pentest is a part of regularly scheduled operations, or any combination thereof.

In some examples, the attribute(s) may include annotations and/or tags. For example, the autonomous pentesting agent may receive an indication for one or more of the network assets, such as via a user input. The user input may indicate an addition of one or more labels, removal of one or more labels, or a combination thereof. The labels may be examples of annotations associated with the one or more network assets (e.g., extra information associated with the network asset), tags indicating priority levels of the one or more network assets, or both. An annotation may explain, as an example, that a weakness identified by a pentest is a false positive, that a weakness is acceptable, or the like. Tags may categorize assets into priority levels (e.g., low, medium, high, or informational priority), indicate that an asset is critical, indicate that an asset is to be ignored during pentesting (e.g., refrain from indicating vulnerabilities associated with the asset in a report), be parents of other tags (e.g., a Microsoft structured query language (SQL) server (MS SQL) tag may be a child of a critical tag), or the like. In some examples, tags may be user-defined. For example, the autonomous pentesting agent may receive an indication of a user-defined tag (e.g., an input to create a user-defined tag) via an exposed application programming interface (API). Tags may be applied to one or more assets, and assets may be associated with one or more tags. Alternatively, annotations may be applicable to a single asset, and assets may have a single annotation.

As an example, the autonomous pentesting agent may receive an indication that the network asset 410-a is associated with a first priority level. That is, a user may “tag” the network asset 410-a with the first priority level by providing the indication. The first priority level may be relatively high and, in some examples, may indicate that the network asset 410-a is a “crown jewel” asset of the network (e.g., an asset with high importance to the network). Additionally, or alternatively, the autonomous pentesting agent may receive an indication that the network asset 415-a is associated with the first priority level. The attribute(s) 420-a of the network asset 410-a and the attribute(s) 425-a of the network asset 415-a may include the indicated first priority level. The indications of labels for one or more of the network assets may be received by the autonomous pentesting agent prior to the first autonomous pentest 405-a, after the first autonomous pentest 405-a but before the second autonomous pentest 405-b, after the second autonomous pentest 405-b, or at multiple instances throughout the multiple autonomous pentests.

The second network assets 415 may be different than the first network assets 410. That is, the autonomous pentesting agent may gain unauthorized access to different network assets during the first autonomous pentest 405-a and the second autonomous pentest 405-b. In some examples, the second network assets 415 may be different than the first network assets 410 based on one or more changes to the network that occurred between the first autonomous pentest 405-a and the second autonomous pentest 405-b. For example, a client may implement security solutions in the network, such as based on a report provided by the autonomous pentesting agent after the first autonomous pentest 405-a. In other words, the network may include changes or security solutions that address one or more vulnerabilities or weaknesses identified during the first autonomous pentest 405-a. Based on the changes to the network, the second network assets 415 may be partially different than the first network assets 410 (e.g., be absent of network assets subject to the changes or security solutions).

Additionally, or alternatively, the first autonomous pentest 405-a may have a different scope or configuration than the second autonomous pentest 405-b. For example, the first autonomous pentest 405-a may be an internal pentest, while the second autonomous pentest 405-b may be an external pentest (e.g., via the Internet). In such examples, the first autonomous pentest 405-a and the second autonomous pentest 405-b may identify different sets of attributes for a same network asset.

In some examples, the autonomous pentesting agent may be unaware of whether the first autonomous pentest 405-a and the second autonomous pentest 405-b are of a same network (e.g., or scope, such as part of a network). The autonomous pentesting agent may determine whether the first autonomous pentest 405-a and the second autonomous pentest 405-b are of a same network based on inferences. For example, the autonomous pentesting agent may use an AI model to determine whether the first autonomous pentest 405-a and the second autonomous pentest 405-b are of a same network by inputting information obtained during the autonomous pentests (e.g., the assets accessed, attribute(s) of the assets, weaknesses and vulnerabilities, etc.). In instances where the autonomous pentesting agent determines that two autonomous pentests were conducted against the same network, the confidence in matching assets between those autonomous pentests may increase. However, a clients may not label the networks subject to external pentesting. In such examples, inferences may be made about whether the same network was used across pentesting operations and asset matching may proceed accordingly. In other words, the autonomous pentesting agent may perform asset matching based on an inference that the first autonomous pentest 405-a and the second autonomous pentest 405-b were of a same network.

In some examples, the autonomous pentesting agent may match one or more first network assets of the first network assets 410 with one or more second network assets of the second network assets 415. For example, the autonomous pentesting agent may identify changes to security vulnerabilities and weaknesses between the first autonomous pentest 405-a and the second autonomous pentest 405-b by identifying and reporting similarities and differences in the network assets that the autonomous pentesting agent gained unauthorized access to during each of the autonomous pentests. The autonomous pentesting agent may match one or more first network assets with one or more second network assets based on similarity scores.

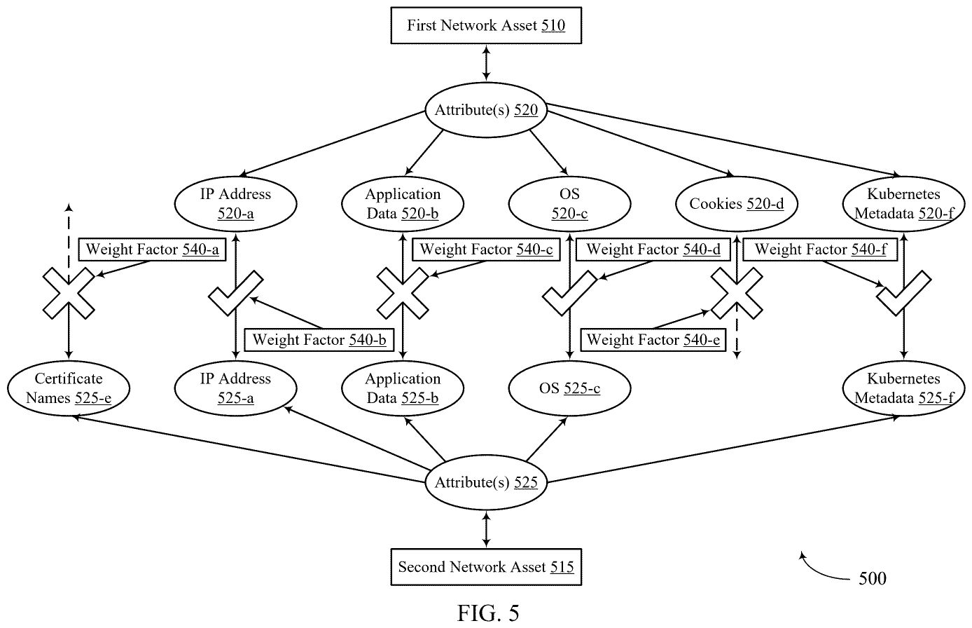

For example, the autonomous pentesting agent may generate similarity scores 430. Generating the similarity scores 430 may involve comparing respective attributes of each network asset of the first network assets 410 to respective attributes of each network asset of the second network assets 415. As an example, the autonomous pentesting agent may generate similarity scores between attribute(s) 420-a of the network asset 410-a and attribute(s) 425-a of the network asset 415-a, attribute(s) 425-b of the network asset 415-b, and attribute(s) 425-c of the network asset 415-c; between attribute(s) 420-b of the network asset 410-b and attribute(s) 425-a of the network asset 415-a, attribute(s) 425-b of the network asset 415-b, and attribute(s) 425-c of the network asset 415-c; and between attribute(s) 420-c of the network asset 410-c and attribute(s) 425-a of the network asset 415-a, attribute(s) 425-b of the network asset 415-b, and attribute(s) 425-c of the network asset 415-c. Generation of the similarity scores 430 may be described in greater detail elsewhere herein, including with reference to FIG. 5.

In some examples, the autonomous pentesting agent may perform the network asset matching 435 based on one or more labels (e.g., tags and/or annotations). For example, the attribute(s) associated with the first network assets 410, the second network assets 415, or both may include tags (e.g., user-provided tags), such as tags indicating asset categorization (e.g., identifying a type of device the asset is, such as a router, printer, laptop, etc.). In such examples, the autonomous pentesting agent may adjust a network asset matching algorithm based on a category of an asset indicated by a tag. For example, the autonomous pentesting agent may adjust weights of different attributes based on the category of asset indicated by the tag, such as to emphasize attributes that are more relevant and/or de-emphasize attributes that are less relevant to the category of asset.

In examples in which the first autonomous pentest 405-a and the second autonomous pentest 405-b have different scopes or configurations and identify different attributes at same network assets, generating the similarity scores 430 may involve comparing attributes common to each pentesting operation. That is, in some examples, attribute(s) that are common to each pentest may be used for the similarity scores 430. Alternatively, a lack or addition of attribute(s) may be used for the similarity scores 430.

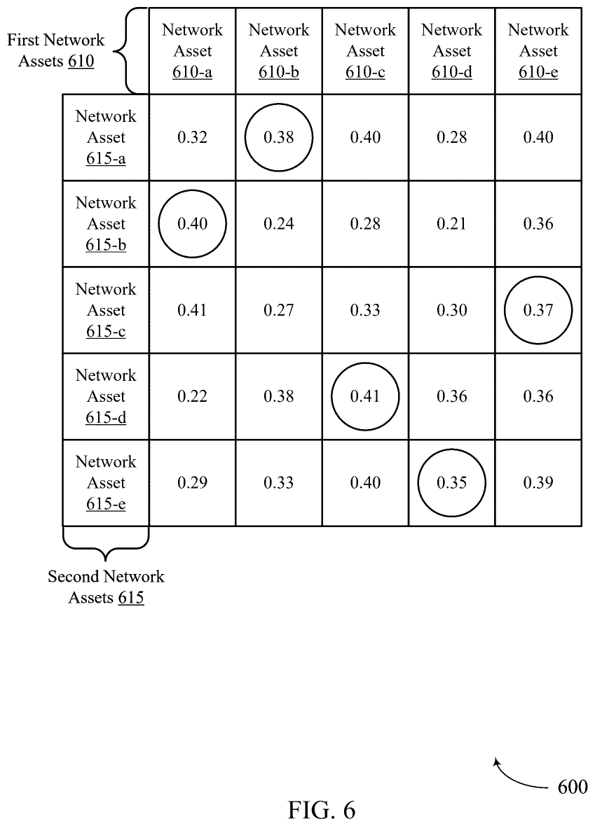

The autonomous pentesting agent may perform network asset matching 435 based on the similarity scores 430. For example, the autonomous pentesting agent may organize the similarity scores 430 into a matrix. A first dimension of the matrix may include, in each column, respective network assets of the first network assets 410, and a second dimension of the matrix may include, in each row, respective network assets of the second network assets 415. Entries in the matrix may be similarity scores between a network asset of the first network assets 410 and a network asset of the second network assets 415. An exemplary matrix and network asset matching may be described in greater detail elsewhere herein, including with reference to FIG. 6.

In the example of FIG. 4, the autonomous pentesting agent may match a network asset 410-a with a network asset 415-a, a network asset 410-b with a network asset 415-b, and a network asset 410-c with a network asset 415-c. In some examples, the autonomous pentesting agent may not match all of the first network assets 410 accessed during the first autonomous pentest 405-a with all of the second network assets 415 accessed during the second autonomous pentest 405-b. In other words, because the different autonomous pentests may access different network assets (e.g., based on changes to the network, variability in the autonomous pentesting, etc.), the autonomous pentesting agent may match a subset of (e.g., one or more of) the first network assets 410 with the second network assets 415.

The autonomous pentesting agent may output a report of the network asset matching 435. For example, the autonomous pentesting agent may report an assessment of the network indicating security information that is based on the matching. In other words, the autonomous pentesting agent may evaluate security vulnerabilities and weaknesses of the network across different autonomous pentests, where the evaluation is based on the assets being matched. As an example, the autonomous pentesting agent may report that a security vulnerability present at the network asset 410-a during the first autonomous pentest 405-a is absent during the second autonomous pentest 405-b at the network asset 415-a matched to the network asset 410-a. Alternatively, the autonomous pentesting agent may report a new security vulnerability at the network asset 415-b during the second autonomous pentest 405-b that was not identified during the first autonomous pentest 405-a at the network asset 410-b matched to the network asset 415-b.

In some examples, the autonomous pentesting agent may link (e.g., associate) annotations, tags, or both of assets from the first autonomous pentest 405-a to matched assets from the second autonomous pentest 405-b and/or weaknesses identified during pentesting. The report may indicate such annotations and/or tags. For example, the autonomous pentesting agent may receive one or more inputs to apply the label 440 to the network asset 410-a prior to the second autonomous pentest 405-b. After matching the network asset 410-a to the network asset 415-a following the second autonomous pentest 405-b, the autonomous pentesting agent may apply the label 440 assigned to the network asset 410-a to the network asset 415-b due to the match between network asset 410-a and 415-a. Put another way, the autonomous pentesting agent may support annotation and/or tag persistence across autonomous pentests as assets are matched in accordance with the network asset matching 435 as described herein.

Additionally, the autonomous pentesting agent may apply the label 440 to one or more weaknesses associated with the network asset 410-a and the network asset 415-b identified during the first autonomous pentest 405-a and the second autonomous pentest 405-b. For example, when a user tags a network asset, the autonomous pentesting agent may identify a finding from one or more autonomous pentests (e.g., a most recent, relevant finding) and tag the finding. Put another way, the autonomous pentesting agent may expose weaknesses found during autonomous pentests for network assets that have been tagged by a user, such as network assets that have been tagged as “critical.” In some examples, the autonomous pentesting agent may link tickets (e.g., information technology (IT) tickets) with associated assets. For instance, the autonomous pentesting agent may apply a tag or annotation to a network asset that corresponds to or is associated with an IT ticket, such as an open IT ticket. In such examples, if the network asset is exploited during a given pentest, the IT ticket may be associated or linked with the network asset after exploitation, indicating to a security team managing open IT tickets that the weakness has not been resolved.

The report may prioritize security vulnerabilities in accordance with the annotations, the tags, or both. For example, the report may include a ranked list of weaknesses present in both the first autonomous pentest 405-a and the second autonomous pentest 405-b, where the list is ranked based on priority levels of network assets indicated by the tags. The report may optionally indicate or include annotations associated with the network assets. In some examples, the report may be filtered according to the tags. For instance, the autonomous pentesting agent may receive one or more inputs to filter assets having a tag associated with a given priority level. By ranking and/or filtering weaknesses found during the autonomous pentests according to the tags, the autonomous pentesting agent may allow a user receiving the report to better allocate resources to remediate weaknesses of high-priority network assets.

After the autonomous pentesting agent matches the network assets, various interactions with a client (e.g., customer, owner of the network, member of the network, etc.) may occur. For example, the matching may provide an accurate quantity (e.g., count) of network assets, which may be used for network assessment (e.g., billing). The autonomous pentesting agent may provide a full list of network assets and associated attributes to the client for record-keeping. Additionally, or alternatively, the autonomous pentesting agent may track network security trends over time (e.g., across different autonomous pentests) using the asset matching, allowing security weaknesses and vulnerabilities to be monitored and mitigated for each network asset. In some examples, findings and conclusions from autonomous pentests (e.g., network security tests) may be correlated across autonomous pentests, such as based on the matching and an associated confidence level.

The autonomous pentesting agent may perform one or more operations after the network asset matching 435. That is, after matching the network asset 410-a to the network asset 415-a and automatically applying the label 440 to the network asset 415-b, the autonomous pentesting agent may perform operations related to the network asset 415-a based on the label 440. For example, the autonomous pentesting agent may generate one or more recommendations for deployment of tripwires based on labels (e.g., annotations, tags, or both). Tripwires (also referred to as honeytokens) refer to digital resources that are deployed to a network to attract malicious actors and detect security threats. A tripwire may be stored on a network asset (such as a real or virtual host machine) in the network. When a malicious actor accesses the tripwire, an alert is transmitted to a network administrator or a program monitoring for security events. During the first autonomous pentest 405-a, the second autonomous pentest 405-b, or both, the autonomous pentesting agent may identify one or more locations within the network to deploy tripwires. The autonomous pentesting agent may prioritize locations associated with high priority levels, based on tags and/or annotations, for instance. In some examples, the report may indicate one or more recommendations for deployment of tripwires. In such examples, the autonomous pentesting agent may receive one or more inputs authorizing the deployment of tripwires in accordance with the one or more recommendations and, in response to the one or more inputs, deploy the tripwires accordingly. Additionally, or alternatively, the tags and/or annotations may identify an asset for deployment of a tripwire (e.g., a user input requesting deployment of a tripwire). The autonomous pentesting agent may correlate a user input of the tags and/or annotations with network assets discovered during pentesting to identify the network asset having tags and/or annotations indicating deployment of a tripwire.

FIG. 5 shows an example of similarity scoring 500 that supports network asset matching across network pentests in accordance with aspects of the present disclosure. The similarity scoring 500 may implement or be implemented by the computing environment 100, the autonomous pentest map 200, the computing environment 300, the network asset matching procedure 400, or any combination thereof. For example, the similarity scoring 500 may illustrate a comparison of attributes and weighting of attribute similarities across multiple attributes of network assets. The first network asset 510 and the second network asset 515 may be examples of network assets identified during different autonomous pentests, such as via the first autonomous pentest 405-a and the second autonomous pentest 405-b described with reference to FIG. 4. That is, the first network asset 510 may be an asset of the first network assets 410 accessed during the first autonomous pentest 405-a, and the second network asset 515 may be an asset of the second network assets 415 accessed during the second autonomous pentest 405-b. Additionally, the attribute(s) 520 may be examples of or include the attribute(s) 420-a, the attribute(s) 420-b, or the attribute(s) 420-c, while the attribute(s) 525 may be examples of the attribute(s) 425-a, the attribute(s) 425-b, or the attribute(s) 425-c.

An autonomous pentesting agent may determine a similarity score between the first network asset 510 and the second network asset 515 based on comparisons of respective attributes of each of the network assets and a weighting of each of the comparisons. For example, the first network asset 510 may have attribute(s) 520, including an IP address 520-a, application data 520-b, an OS 520-c, cookies 520-d, and Kubernetes metadata 520-f. The second network asset 515 may have attribute(s) 525 including an IP address 525-a, application data 525-b, an OS 525-c, certificate names 525-e, and Kubernetes metadata 525-f.

The IP address 520-a and the IP address 525-a, the OS 520-c and the OS 525-c, and the Kubernetes metadata 520-f and the Kubernetes metadata 525-f may match. In such examples, the autonomous pentesting agent may assign a similarity score between the IP addresses, the OSs, and the Kubernetes metadata of 1 (e.g., there is a perfect match). Alternatively, the application data 520-b and the application data 525-b may not match. In such examples, the autonomous pentesting agent may assign a similarity score between the application data of less than 1 (e.g., there is not a perfect match).

While the attributes in the example of FIG. 5 are illustrated as either matching or not matching, it may be understood that there may be a partial match (e.g., a similarity score between 0 and 1) for one or more of the assets. For example, the OSs may be assigned a similarity score of less than 1 but more than 0 in examples in which the OSs have different versions, but are a same OS. As another example, the application data may be assigned a similarity score between 1 and 0 for having a partial match in application data (e.g., 0 being no overlapping or matching data and 1 being a complete match).

In some examples, the attribute(s) 520 of the first network asset 510 and the attribute(s) of the second network asset 515 may include different attributes. That is, the autonomous pentesting agent may identify cookies 520-d of the first network asset 510, but no cookies for the second network asset 515. Similarly, the autonomous pentesting agent may identify certificate names 525-e for the first network asset 510 but not for the second network asset 515. In such examples, the autonomous pentesting agent may include attributes that are common to both the first network asset 510 and the second network asset 515. That is, the difference in attributes may be based on a varying scope or configuration of an autonomous pentest during which the first network asset 510 and the second network asset 515 were identified. In such examples, the difference in attributes may not be indicative of a difference between the first network asset 510 and the second network asset 515. Rather, the difference may be attributed to the differing scope or configuration between autonomous pentests. Alternatively, the autonomous pentesting agent may include attributes that are not common to both the first network asset 510 and the second network asset 515 in the similarity score. For example, lack of an attribute at one of the first network asset 510 or the second network asset 515 when the attribute is present at the other network asset may indicate a difference between the first network asset 510 and the second network asset 515. In other words, all known attributes of the first network asset 510 and the second network asset 515 may be examined to compute a correlation factor (e.g., a similarity score between attributes).

The correlation factors (e.g., similarity scores between attributes) may be scaled according to weights associated with the attribute(s). The autonomous pentesting agent may assign weighting factors to each attribute. For example, the autonomous pentesting agent may assign a weight factor 540-a to certificate names, a weight factor 540-b to IP addresses, a weight factor 540-c to application data, a weight factor 540-d to OSs, a weight factor 540-e to cookies, and a weight factor 540-f to Kubernetes metadata. The autonomous pentesting agent may assign the weighting factors to each attribute based on data varying across autonomous pentests.

The autonomous pentesting agent may apply a higher weighting factor to attributes that are more likely to remain static over time. Additionally, or alternatively, the autonomous pentesting agent may apply a lower weighting factor to attributes that are more likely to be dynamic over time. As an example, the weight factor 540-d assigned to the OSs may be relatively higher than the weight factor 540-c assigned to the application data, as the OS is more likely to be the same for a given asset over time than the application data. Other attributes that may be assigned relatively high weighting factors include host names, MAC addresses, resource name identifiers (e.g., ARNs), and subnets.

In some examples, a match in an attribute may be indicative of a matched asset (e.g., without consideration of other attributes). For example, a match between the Kubernetes metadata 520-f and the Kubernetes metadata 525-f may, regardless of matches or mismatches between the other attributes, indicate a match between the first network asset 510 and the second network asset 515. Put another way, the weight factor 540-f applied to a similarity score of the Kubernetes metadata may be such that the other similarity scores are negligible. In such examples, the autonomous pentesting agent may perform network asset matching in accordance with Kubernetes metadata (if present).

The autonomous pentesting agent may obtain the Kubernetes metadata via autonomous pentesting or, in some examples, by using an algorithm (e.g., a best effort algorithm) to extract Kubernetes workload information from host names of network assets (in examples where the network assets are hosts). Additionally, or alternatively, the autonomous pentesting agent may perform network asset matching in accordance with the similarity scoring and matching algorithm described herein. For example, if the attribute(s) 520 and the attribute(s) 525 include Kubernetes metadata, the autonomous pentesting agent may determine whether the first network asset 510 and the second network asset 515 match in accordance with the Kubernetes metadata (e.g., alone); however, if the attribute(s) 520 and the attribute(s) 525 are absent of Kubernetes metadata, the autonomous pentesting agent may attempt to extract Kubernetes workload information and/or assess similarities of the other attributes to determine whether the first network asset 510 and the second network asset 515 match.

In some examples, the autonomous pentesting agent may use the Kubernetes metadata identified across multiple autonomous pentests to track a system load. For example, the autonomous pentesting agent may track a system load over time (e.g., via Kubernetes metadata) to show how an attack may stress a system. In such examples, the autonomous pentesting agent may apply labels (e.g., annotations and/or tags) based on the tracking to highlight weaknesses.

The weighting factors may be manually tuned. For example, the autonomous pentesting agent may receive one or more user inputs increasing or decreasing one or more weighting factors assigned to one or more attributes. The autonomous pentesting agent may update similarity scores between network assets generated prior to receiving the user inputs, apply the updated weighting factors to subsequent asset matching procedures, or both. Additionally, or alternatively, the weighting factors may be tuned based on an AI or ML model. For example, the AI or ML model may be trained against one or more sample sets where the true network asset matchings are labeled. In other words, the AI or ML model may output weighting factors for one or more attributes (e.g., or adjustments thereof) based on an input of labeled network asset matches between autonomous pentests (e.g., or other security operations). That is, the AI or ML model may be used to identify which attributes and weighting factors correspond to successfully matching the network assets.

In some examples, the weighting factors may be based on a setup of the network (e.g., a client network setup). For example, the autonomous pentesting agent may determine the weighting factors based on identifying information about the setup of the network during autonomous pentest(s), via user input, by accessing stored information, or the like. Additionally, or alternatively, the weighting factors may be based on services running on the network. As an example, an attribute may indicate the presence of a service on the network. Such an attribute may be weighted relatively higher if fewer network assets have the service. That is, the service may be more likely to indicate a match between network assets based on relatively few network assets having the service.

The autonomous pentesting agent may determine a similarity score between the first network asset 510 and the second network asset 515. The similarity score may be a summation of the correlation factors (e.g., individual similarity scores) between each attribute of the attribute(s) 520 and the attribute(s) 525.

In some examples, the autonomous pentesting agent may group attributes into a composite attribute and assign a weighting factor to the composite attribute (e.g., rather than individual attributes). For example, the attribute(s) may include one or more composite attributes, such as a composite network attribute, a composite device attribute, and a composite resource attribute. The network composite attribute may have relatively fewer attributes compared to the composite device attribute and the composite resource attribute. However, the attributes of the network composite attribute may be relatively more significant than other attributes (e.g., more static, less likely to change over time, more likely to indicate a match, etc.). The resource composite attribute may have relatively more attributes that are relatively less significant compared to the network composite attribute (e.g., more dynamic, less likely to indicate a match, etc.). The autonomous pentesting agent may apply a same weighting factor to the network composite attribute as the resource composite attribute such that a bias towards the many attributes in the resource composite attribute may be reduced. That is, the weighting factor being applied evenly to the network composite attribute and the resource composite attribute may favor the attributes of the network composite attribute as fewer attributes are involved compared to the resource composite attribute.

The weighting factors may be based on labels. For example, the autonomous pentesting agent may receive user inputs indicating labels (e.g., customer annotations or tags, such as the label 440 as described with reference to FIG. 4) associated with one or more network assets. In an example, the autonomous pentesting agent may receive a user input labeling the first network asset 510 as having a priority level. The label of the first priority level may be included in the attribute(s) 520 based on receiving the user input.

In addition to or alternatively from matching network assets across autonomous pentests, the autonomous pentesting agent may use techniques described herein to identify whether network assets are externally-owned (e.g., third-party assets). For example, the autonomous pentesting agent may perform an external asset discovery procedure (e.g., port scanning) prior to a first autonomous pentest (e.g., prior to an external pentest). During the external asset discovery procedure, the autonomous pentesting agent may identify one or more assets of a network exposed externally (e.g., outside the organization, to the Internet, etc.). Additionally, the autonomous pentesting agent may obtain information associated with external assets, including attributes (e.g., domain name, identity service provider (ISP), certificates, secure sockets layer (SSL) certificates, etc.). The autonomous pentesting agent may compare attributes associated with the identified external assets to attributes of a list of third-party attributes (e.g., to “match” or identify whether the external assets are third-party assets). The autonomous pentesting agent may perform autonomous pentests in accordance with identifying whether the external assets are third-party assets. For example, the autonomous pentesting agent may refrain from performing pentesting operations that target or involve third-party assets. Additionally, or alternatively, the autonomous pentesting agent may perform network asset matching based on whether network assets are externally owned. That is, the autonomous pentesting agent may use ownership (e.g., whether a network asset is externally owned) as an attribute for the network asset matching described herein.

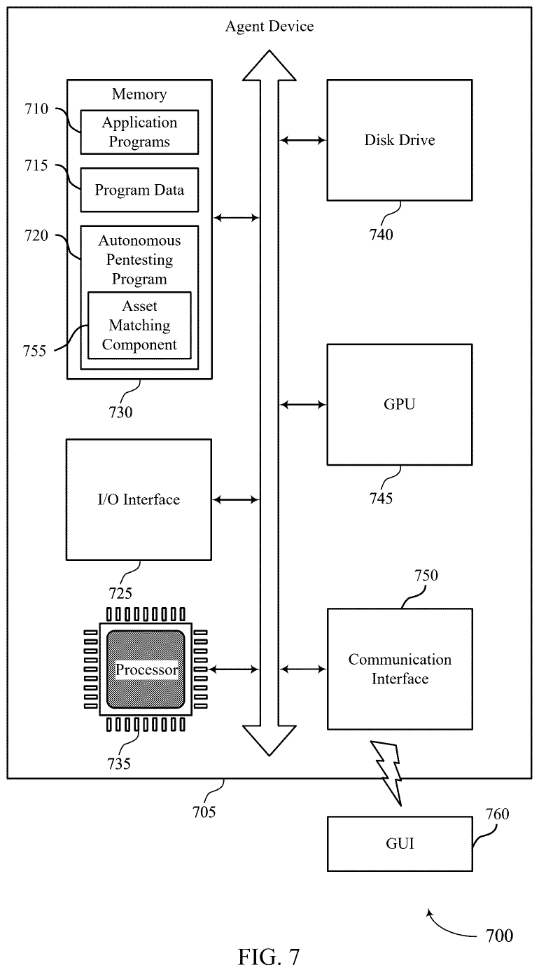

In some examples, the autonomous pentesting agent may perform the external asset discovery procedure continuously (e.g., on a periodic basis). For example, the autonomous pentesting agent may perform a periodic port scanning procedure. The autonomous pentesting agent may output an indication of external network assets identified based on the periodic port scanning procedure. In some examples, the autonomous pentesting agent may output the indication via a dynamic user interface (e.g., a graphical user interface (GUI), which may be described in greater detail elsewhere herein, including with reference to FIG. 7). That is, the autonomous pentesting agent may continuously update a user interface with indications of identified external assets. The autonomous pentesting agent, based on outputting the indication of the external network assets, may receive one or more inputs indicating authorization to pentest one or more of the external network assets. For example, a user may authorize the autonomous pentesting agent to perform an autonomous pentest of external network assets based on security or permissions of external network assets (e.g., whether the assets are owned by a third-party and, if so, whether the third-party allows the assets to be pentested).

FIG. 6 shows an example of an asset matching matrix 600 that supports network asset matching across network pentests in accordance with aspects of the present disclosure. The asset matching matrix 600 may implement or be implemented by the computing environment 100, the autonomous pentest map 200, the computing environment 300, the network asset matching procedure 400, the similarity scoring 500, or any combination thereof. For example, the asset matching matrix 600 may illustrate a matrix of similarity scores between respective network assets identified during different autonomous pentests, such as the first network assets 410 and the second network assets 415 identified during the first autonomous pentest 405-a and the second autonomous pentest 405-b, respectively, described with reference to FIG. 4. That is, the first network assets 610 and the second network assets 615 may be examples of the first network assets 410 and the second network assets 415, respectively, described with reference to FIG. 4.

The asset matching matrix 600 may include, along a first dimension, first network assets 610 and, along a second dimension, second network assets 615. The asset matching matrix 600 may include entries corresponding to similarity scores between respective first network assets of the first network assets 610 and respective second network assets of the second network assets 615. As an example, a first entry in a first column and a first row of the matrix may be a similarity score between the network asset 610-a and the network asset 615-a. The similarity scores included in the asset matching matrix 600 may be generated for each combination of network assets using the similarity scoring described with reference to FIG. 5. For example, the similarity score generated in the example of FIG. 5 may be input as an entry to the asset matching matrix 600.

In some examples, techniques described herein may be applied to match network assets across two or more autonomous pentests. For example, the autonomous pentesting agent may perform successive matching across two or more autonomous pentests, where one or more network assets of a first autonomous pentest are matched with one or more second network assets of a second autonomous pentest. The one or more network assets matched from the first autonomous pentest and the second autonomous pentest may produce a set of combined network assets. That is, the one or more first network assets and the one or more second network assets that are matched may produce a set of combined network assets. The autonomous pentesting agent may perform a third pentest and match the set of combined network assets to one or more third network assets of the third autonomous pentest. By using the matched network assets to compare to subsequent pentests, the autonomous pentesting agent may perform the network asset matching over multiple (e.g., more than two) autonomous pentests.

After similarity scores are generated for each pairing of network assets from the first network assets 610 and network assets from the second network assets 615, an autonomous pentesting agent may match network assets such that a solution, such as an optimal matching solution, is identified. As used herein, an “optimal” matching solution may involve choosing a set of matches between network assets of a first autonomous pentest and network assets of a second autonomous pentest that maximizes a total similarity score (e.g., a sum of similarity scores of each match or pair exceeds a threshold), under a constraint that a network asset from the first autonomous pentest or the second autonomous pentest can be matched to, at most, one network asset from the other autonomous pentest. In some examples, a matching solution may include a match that is sub-optimal (e.g., similarity score below a threshold) for a given asset (e.g., not the highest similarity score possible for that asset). In such cases, the matching solution may still be acceptable (or considered optimal) because when considered amongst all other matches (and respective similarity scores for the other matches), the match may still be the highest sum total across all the matches in the first and second pentests, given the constraints or conditions. Thus, the “sub-optimal” match may contribute to a highest total similarity score across all matches and therefore may be considered a match. In some examples, the autonomous pentesting agent may apply an assignment problem algorithm (e.g., the Hungarian algorithm) to match the network assets. In the example of the asset matching matrix 600, the autonomous pentesting agent may match (e.g., based on an assignment problem algorithm) network asset 615-a to network asset 610-b, network asset 615-b to network asset 610-a, network asset 615-c to network asset 610-e, network asset 615-d to network asset 610-c, and network asset 615-e to network asset 610-d.

In some examples, the autonomous pentesting agent may refrain from matching one or more network assets. For example, the autonomous pentesting agent may eliminate one or more matches as being candidates in the asset matching matrix 600 based on a similarity score threshold (e.g., a minimum similarity score), a mismatch in an attribute, or both.

For example, the autonomous pentesting agent may apply a similarity score threshold. In accordance with the similarity score threshold, the matched assets 645 identified by the autonomous pentesting agent may satisfy (e.g., be greater than) the similarity score threshold. In such examples, the autonomous pentesting agent may remove one or more matches that are identified according to an assignment problem algorithm. As an example, for a similarity score threshold of 0.3, the autonomous pentesting agent may remove a match between the network asset 610-a and the network asset 615-e having a similarity score of 0.29. In other words, the autonomous pentesting agent, when determining security information across pentests, may determine that the network asset 610-a and the network asset 615-e are not the same in accordance with the similarity score being below the threshold similarity score (e.g., despite the assignment problem algorithm identifying the match).

Additionally, or alternatively, the autonomous pentesting agent may remove one or more matches based on a mismatch between one or more attributes. For example, the autonomous pentesting agent may remove one or more matches or refrain from matching network assets having a mismatch between a cloud resource name (e.g., an ARN), whether the network asset is publicly accessible (e.g., ispublic), or the like. A mismatch between such attributes may indicate that the network assets are not the same with a relatively high confidence level (e.g., compared to other attributes). In some examples, the autonomous pentesting agent may modify the similarity scores between network assets having a mismatch in a given attribute to being zero such that the assignment problem algorithm does not match the network assets (e.g., or the similarity score is below the threshold). Alternatively, the autonomous pentesting agent may refrain from matching the network assets after matching the assets according to the assignment problem algorithm. That is, the autonomous pentesting agent may remove the match and determine that the network assets are different.

FIG. 7 shows a diagram of a system 700 including an agent device 705 that supports network asset matching across network pentests in accordance with aspects of the present disclosure. The agent device 705 may be an example of a device or server on which an autonomous pentesting agent 105 is deployed as described herein. The agent device 705 may include components for network asset matching across network pentests, such as a memory 730 including application programs 710, program data 715, an autonomous pentesting program 720, and an asset matching component 755; an input/output (I/O) interface 725; a processor 735; a disk drive 740; a graphics processing unit (GPU) 745; and a communication interface 750. Each of these components may communicate, directly or indirectly, with one another (e.g., via one or more buses, communications links, communications interfaces, or any combination thereof).

The I/O interface 725 may support connection of the agent device 705 with one or more other devices. For example, the agent device 705 may connect to keyboards, mice, printers, hard disks, or the like via the I/O interface 725. The I/O interface 725 may communicate with the processor 735. That is, the processor 735 may process signals from devices connected to the agent device 705 via the I/O interface 725.

Memory 730 may include RAM, ROM, or both. The memory 730 may store computer-readable, computer-executable software including instructions that, when executed, cause at least one processor 735 to perform various functions described herein, such as functions supporting network asset matching across network pentests. In some cases, the memory 730 may contain, among other things, a basic I/O system (BIOS), which may control basic hardware or software operation such as the interaction with peripheral components or devices. The memory 730 may be an example of a single memory or multiple memories. For example, the agent device 705 may include one or more memories 730.

The application programs 710 in the memory 730 may be examples of app(s) 140 as described with reference to FIG. 1. For example, the application programs 710 may be installed on the memory 730 of the agent device 705, among other devices in a network. The application programs 710 may be examples of software applications or computer programs that are implemented to carry out one or more functions or tasks.

The program data 715 may be data related to the application programs 710. Program data 715 may be an example of or refer to running data of programs and applications installed on the memory 730 of the agent device 705. In some examples, the program data 715 may include various data, including code that allows the application programs 710 to perform the one or more functions or tasks.

The processor 735 may include an intelligent hardware device, (e.g., a general-purpose processor, a digital signal processor (DSP), a central processing unit (CPU), a microcontroller, an application-specific integrated circuit (ASIC), a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting network asset matching across network pentests). Though a single processor 735 is depicted in the example of FIG. 7, it is to be understood that the system 700 may include any quantity of one or more of processors 735 and that a group of processors 735 may collectively perform one or more functions ascribed herein to a processor, such as the processor 735. The processor 735 may be an example of a single processor or multiple processors. For example, the agent device 705 may include one or more processors 735.

The disk drive 740 may be configured to store data that is generated, processed, stored, or otherwise used by the system 700. In some cases, the disk drive 740 may include one or more hard disk drives (HDDs), one or more solid-state drives (SSDs), or both. In some examples, the disk drive 740 may be an example of a single database, a distributed database, multiple distributed databases, a data store, a data lake, or an emergency backup database. In some examples, the disk drive 740 may be an example of one or more components described with reference to FIG. 1.

GPU 745 may be configured to store graphics-related data. The GPU 745 may store and manage data related to graphics and video processing. In some examples, the GPU 745 may be an example of or a component of a graphics card. The GPU 745 may use components of the memory 730, including the RAM, for temporary storage. For example, the GPU 745 may move data from the RAM of the memory 730 to the GPU 745 for graphics and video processing.

The communication interface 750 may enable the agent device 705 to exchange information (e.g., input information, output information, or both) with other systems or devices, such as a GUI 760. For example, the agent device 705 may update the GUI 760 via the communication interface 750. The GUI 760 may allow users to interact with a computer or device (different than the agent device 705) through visual elements like icons, buttons, and menus. The communication interface 750 may enable the agent device 705 to connect to a network (e.g., a network 110 as described herein). The communication interface 750 may include one or more wireless network interfaces, one or more wired network interfaces, or any combination thereof.

The autonomous pentesting program 720 may be an example of a program of an autonomous pentesting service that is installed on the memory 730 of the agent device 705. The autonomous pentesting program 720 may execute an autonomous pentest of a network accessed by the agent device 705, such as accessed via the communication interface 750. That is, the autonomous pentesting program 720 may be configured to perform an autonomous pentest as described herein, including an autonomous pentest involving network asset matching.

The asset matching component 755 may support network asset matching in accordance with examples as disclosed herein. For example, the asset matching component 755 may be configured as or otherwise support a means for executing a first autonomous pentest of a network. In some examples, to execute the first autonomous pentest, the asset matching component 755 may be further configured as or otherwise support a means for gaining unauthorized access to a first set of network assets of the network and obtaining respective first sets of attributes for the first set of network assets. The asset matching component 755 may be configured as or otherwise support a means for executing a second autonomous pentest of the network In some examples, to execute the first autonomous pentest, the asset matching component 755 may be further configured as or otherwise support a means for gaining unauthorized access to a second set of network assets of the network and obtaining respective second sets of attributes for the second set of network assets. The asset matching component 755 may be configured as or otherwise support a means for performing a network asset matching procedure to match one or more first network assets of the first set of network assets with one or more second network assets of the second set of network assets, the network asset matching procedure based at least in part on similarity scores between the respective first sets of attributes and the respective second sets of attributes. The asset matching component 755 may be configured as or otherwise support a means for outputting a network assessment report indicating network security information associated with the network based at least in part on the network asset matching procedure.

By including or configuring the asset matching component 755 in accordance with examples as described herein, the agent device 705 may support techniques for improved network security.

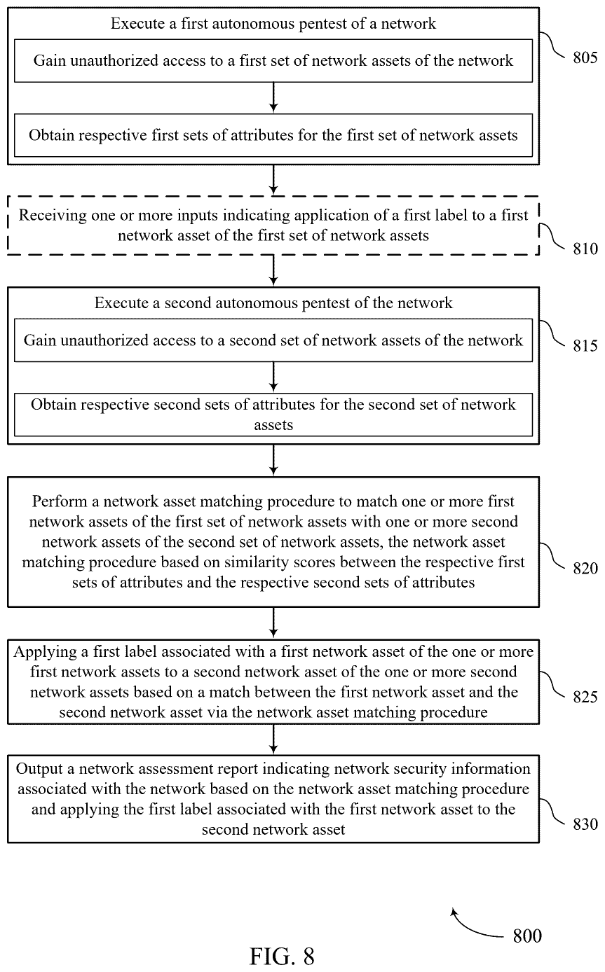

FIG. 8 shows a flowchart illustrating a method 800 that supports network asset matching across network pentests in accordance with aspects of the present disclosure. The operations of the method 800 may be implemented by an agent device 705 or its components as described herein. In some examples, an agent device may execute a set of instructions to control the functional elements of the agent device to perform the described functions. Additionally, or alternatively, the agent device may perform aspects of the described functions using special-purpose hardware.

At 805, the method may include executing a first autonomous pentest of a network. In some examples, executing the first autonomous pentest may include gaining unauthorized access to a first set of network assets of the network and obtaining respective first sets of attributes for the first set of network assets.

At 810, the method may include receiving one or more inputs indicating application of a first label to a first network asset of the first set of network assets.

At 815, the method may include executing a second autonomous pentest of the network. In some examples, executing the second autonomous pentest may include gaining unauthorized access to a second set of network assets of the network and obtaining respective second sets of attributes for the second set of network assets.

At 820, the method may include performing a network asset matching procedure to match one or more first network assets of the first set of network assets with one or more second network assets of the second set of network assets, the network asset matching procedure based at least in part on similarity scores between the respective first sets of attributes and the respective second sets of attributes.

At 825, the method may include applying a first label associated with a first network asset of the one or more first network assets to a second network asset of the one or more second network assets based on a match between the first network asset and the second network asset via the network asset matching procedure.

At 830, the method may include outputting a network assessment report indicating network security information associated with the network based at least in part on the network asset matching procedure and applying the first label associated with the first network asset to the second network asset.

The following provides an overview of aspects of the present disclosure:

Aspect 1: A method for network asset matching, comprising: executing a first autonomous pentest of a network, wherein executing the first autonomous pentest comprises: gaining unauthorized access to a first set of network assets of the network; and obtaining respective first sets of attributes for the first set of network assets; executing a second autonomous pentest of the network, wherein executing the second autonomous pentest comprises: gaining unauthorized access to a second set of network assets of the network; and obtaining respective second sets of attributes for the second set of network assets; performing a network asset matching procedure to match one or more first network assets of the first set of network assets with one or more second network assets of the second set of network assets, the network asset matching procedure based at least in part on similarity scores between the respective first sets of attributes and the respective second sets of attributes; applying a first label associated with a first network asset of the one or more first network assets to a second network asset of the one or more second network assets based at least in part on a match between the first network asset and the second network asset via the network asset matching procedure; and outputting a network assessment report indicating network security information associated with the network based at least in part on the network asset matching procedure and applying the first label associated with the first network asset to the second network asset.

Aspect 2: The method of aspect 1, further comprising: assigning a respective weighting factor to each attribute of the respective first sets of attributes and of the respective second sets of attributes, wherein performing the network asset matching procedure comprises: generating the similarity scores based at least in part on respective weighting factors.

Aspect 3: The method of aspect 2, wherein assigning the respective weighting factor to each attribute comprises: assigning a first weighting factor to a first attribute; and assigning a second weighting factor to a second attribute, wherein the first weighting factor is greater than the second weighting factor, and wherein the first attribute is static over time relative to the second attribute.

Aspect 4: The method of any of aspects 2 through 3, wherein the respective weighting factors are determined based at least in part on a configuration of the network and on one or more services running on the network.

Aspect 5: The method of any of aspects 2 through 4, wherein assigning the respective weighting factor comprises: assigning a weighting factor to a composite attribute, the composite attribute comprising two or more attributes of the respective first sets of attributes and of the respective second sets of attributes.

Aspect 6: The method of any of aspects 2 through 5, further comprising: receiving one or more user inputs that indicate the respective weighting factors, wherein assigning the respective weighting factor to each attribute is in accordance with the one or more user inputs.

Aspect 7: The method of any of aspects 1 through 6, wherein performing the network asset matching procedure comprises: generating a matrix having a first dimension corresponding to the first set of network assets and having a second dimension corresponding to the second set of network assets, wherein respective entries of the matrix comprise the similarity scores between the respective first sets of attributes of each network asset along the first dimension and the respective second sets of attributes of each network asset along the second dimension.

Aspect 8: The method of any of aspects 1 through 7, wherein performing the network asset matching procedure comprises: identifying a mismatch between a first attribute of a third network asset of the first set of network assets and a second attribute of a fourth network asset of the second set of network assets, wherein a match between the third network asset and the fourth network asset is excluded from the match of the one or more first network assets with the one or more second network assets based at least in part on the mismatch.

Aspect 9: The method of any of aspects 1 through 8, wherein a similarity score between a third network asset of the first set of network assets and a fourth network asset of the second set of network assets is below a threshold, and wherein performing the network asset matching procedure comprises: excluding a match between the third network asset and the fourth network asset from the match of the one or more first network assets with the one or more second network assets based at least in part on the similarity score being below the threshold.

Aspect 10: The method of any of aspects 1 through 9, further comprising: calculating the similarity scores based at least in part on: calculating correlation factors between the respective first sets of attributes and the respective second sets of attributes; weighting the correlation factors based at least in part on weighting factors of each respective attribute; and calculating summations of the weighted correlation factors, wherein the similarity scores comprise the summations of the weighted correlation factors.

Aspect 11: The method of any of aspects 1 through 10, wherein outputting the network assessment report comprises: outputting the network assessment report indicating the first set of network assets accessed during the first autonomous pentest and the second set of network assets accessed during the second autonomous pentest.

Aspect 12: The method of aspect 11, wherein the network assessment report further indicates the respective first sets of attributes of each network asset of the first set of network assets and the respective second sets of attributes of each network asset of the second set of network assets.

Aspect 13: The method of any of aspects 1 through 12, wherein the respective first sets of attributes, the respective second sets of attributes, or both comprise a DNS hostname, a hostname, a NetBIOS name, a MAC address, an IP address, machine identifier, a virtual host, a virtual machine identifier, a device fingerprint, a hardware fingerprint, a subnet, a LDAP host name, elastic compute cloud instance identifier, a resource identifier associated with cloud assets, a set of services, open ports, certificate names, SSL certificates, a set of fileshares, a set of applications, application data, OSs, flags, pentest configuration attributes, or any combination thereof.

Aspect 14: The method of any of aspects 1 through 13, wherein the first set of network assets is at least partially different from the second set of network assets.

Aspect 15: The method of any of aspects 1 through 14, wherein the first set of network assets, the second set of network assets, or both comprise sets of hosts of the network.

Aspect 16: The method of any of aspects 1 through 15, wherein performing the network asset matching procedure is based at least in part on an assignment algorithm.

Aspect 17: The method of any of aspects 1 through 16, further comprising: receiving one or more inputs indicating application of the first label to the first network asset of the first set of network assets, wherein applying the first label to the second network asset is based at least in part on receiving the one or more inputs.

Aspect 18: The method of any of aspects 1 through 17, further comprising: receiving one or more inputs indicating application of one or more labels to one or more network assets of the first set of network assets, the second set of network assets, or both; and generating one or more recommendations associated with deployment of tripwires based at least in part on the one or more labels, wherein the network assessment report comprises the one or more recommendations.

Aspect 19: The method of any of aspects 1 through 18, wherein the respective first sets of attributes, the respective second sets of attributes, or both comprise Kubernetes metadata, and wherein performing the network asset matching procedure comprises: matching the one or more first network assets of the first set of network assets with the one or more second network assets of the second set of network assets in accordance with first Kubernetes metadata associated with the one or more first network assets matching second Kubernetes metadata associated with the one or more second network assets.

Aspect 20: The method of any of aspects 1 through 19, further comprising: scanning, prior to the first autonomous penetration test, a plurality of ports of the network to identify a plurality of external network assets associated with respective third sets of attributes; and determining whether each external network asset of the plurality of external network assets comprise third-party assets based at least in part on a comparison between the respective third sets of attributes and respective fourth sets of attributes associated with the third-party assets, wherein the first autonomous penetration test, the second autonomous penetration test, or both exclude attack paths that include the third-party assets.

Aspect 21: The method of any of aspects 1 through 20, further comprising: dynamically updating a user interface with an indication of a plurality of external network assets identified based at least in part on a periodic scan of a plurality of ports of the network; receiving one or more inputs indicating authorization to perform autonomous penetration testing operations targeting one or more external network assets of the plurality of external network assets, wherein the first autonomous penetration test, the second autonomous penetration test, or both are in accordance with the one or more inputs.

Aspect 22: An apparatus for network asset matching, comprising one or more memories storing processor-executable code, and one or more processors coupled with the one or more memories and individually or collectively operable to execute the code to cause the apparatus to perform a method of any of aspects 1 through 21.

Aspect 23: An apparatus for network asset matching, comprising at least one means for performing a method of any of aspects 1 through 21.

Aspect 24: A non-transitory computer-readable medium storing code for network asset matching, the code comprising instructions executable by one or more processors to perform a method of any of aspects 1 through 21.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for network asset matching, comprising:
executing a first autonomous penetration test of a network, wherein executing the first autonomous penetration test comprises:
gaining unauthorized access to a first set of network assets of the network; and
obtaining respective first sets of attributes for the first set of network assets;
executing a second autonomous penetration test of the network, wherein executing the second autonomous penetration test comprises:
gaining unauthorized access to a second set of network assets of the network; and
obtaining respective second sets of attributes for the second set of network assets;
performing a network asset matching procedure to match one or more first network assets of the first set of network assets with one or more second network assets of the second set of network assets, the network asset matching procedure based at least in part on similarity scores between the respective first sets of attributes and the respective second sets of attributes;
applying a first label associated with a first network asset of the one or more first network assets to a second network asset of the one or more second network assets based at least in part on a match between the first network asset and the second network asset via the network asset matching procedure; and
outputting a network assessment report indicating network security information associated with the network based at least in part on the network asset matching procedure and applying the first label associated with the first network asset to the second network asset.

2. The method of claim 1, further comprising:
receiving one or more inputs indicating application of the first label to the first network asset of the first set of network assets, wherein applying the first label to the second network asset is based at least in part on receiving the one or more inputs.

3. The method of claim 1, further comprising:
receiving one or more inputs indicating application of one or more labels to one or more network assets of the first set of network assets, the second set of network assets, or both; and
generating one or more recommendations associated with deployment of tripwires based at least in part on the one or more labels, wherein the network assessment report comprises the one or more recommendations.

4. The method of claim 1, wherein the respective first sets of attributes, the respective second sets of attributes, or both comprise Kubernetes metadata, and wherein performing the network asset matching procedure comprises:
matching the one or more first network assets of the first set of network assets with the one or more second network assets of the second set of network assets in accordance with first Kubernetes metadata associated with the one or more first network assets matching second Kubernetes metadata associated with the one or more second network assets.

5. The method of claim 1, further comprising:
scanning, prior to the first autonomous penetration test, a plurality of ports of the network to identify a plurality of external network assets associated with respective third sets of attributes; and
determining whether each external network asset of the plurality of external network assets comprise third-party assets based at least in part on a comparison between the respective third sets of attributes and respective fourth sets of attributes associated with the third-party assets, wherein the first autonomous penetration test, the second autonomous penetration test, or both exclude attack paths that include the third-party assets.

6. The method of claim 1, further comprising:
dynamically updating a user interface with an indication of a plurality of external network assets identified based at least in part on a periodic scan of a plurality of ports of the network; and
receiving one or more inputs indicating authorization to perform autonomous penetration testing operations targeting one or more external network assets of the plurality of external network assets, wherein the first autonomous penetration test, the second autonomous penetration test, or both are in accordance with the one or more inputs.

7. The method of claim 1, further comprising:
assigning a respective weighting factor to each attribute of the respective first sets of attributes and of the respective second sets of attributes, wherein performing the network asset matching procedure comprises:
generating the similarity scores based at least in part on respective weighting factors.

8. The method of claim 7, wherein assigning the respective weighting factor to each attribute comprises:
assigning a first weighting factor to a first attribute; and
assigning a second weighting factor to a second attribute, wherein the first weighting factor is greater than the second weighting factor, and wherein the first attribute is static over time relative to the second attribute.

9. The method of claim 7, wherein the respective weighting factors are determined based at least in part on a configuration of the network and on one or more services running on the network.

10. The method of claim 7, wherein assigning the respective weighting factor comprises:
assigning a weighting factor to a composite attribute, the composite attribute comprising two or more attributes of the respective first sets of attributes and of the respective second sets of attributes.

11. The method of claim 7, further comprising:
receiving one or more user inputs that indicate the respective weighting factors, wherein assigning the respective weighting factor to each attribute is in accordance with the one or more user inputs.

12. The method of claim 1, wherein performing the network asset matching procedure comprises:
generating a matrix having a first dimension corresponding to the first set of network assets and having a second dimension corresponding to the second set of network assets, wherein respective entries of the matrix comprise the similarity scores between the respective first sets of attributes of each network asset along the first dimension and the respective second sets of attributes of each network asset along the second dimension.

13. The method of claim 1, wherein performing the network asset matching procedure comprises:
identifying a mismatch between a first attribute of a third network asset of the first set of network assets and a second attribute of a fourth network asset of the second set of network assets, wherein a match between the third network asset and the fourth network asset is excluded from the match of the one or more first network assets with the one or more second network assets based at least in part on the mismatch.

14. The method of claim 1, wherein a similarity score between a third network asset of the first set of network assets and a fourth network asset of the second set of network assets is below a threshold, and wherein performing the network asset matching procedure comprises:
excluding a match between the third network asset and the fourth network asset from the match of the one or more first network assets with the one or more second network assets based at least in part on the similarity score being below the threshold.

15. The method of claim 1, further comprising:
calculating the similarity scores based at least in part on:
calculating correlation factors between the respective first sets of attributes and the respective second sets of attributes;
weighting the correlation factors based at least in part on weighting factors of each respective attribute; and
calculating summations of the weighted correlation factors, wherein the similarity scores comprise the summations of the weighted correlation factors.

16. The method of claim 1, wherein outputting the network assessment report comprises:
outputting the network assessment report indicating the first set of network assets accessed during the first autonomous penetration test and the second set of network assets accessed during the second autonomous penetration test.

17. The method of claim 16, wherein the network assessment report further indicates the respective first sets of attributes of each network asset of the first set of network assets and the respective second sets of attributes of each network asset of the second set of network assets.

18. The method of claim 1, wherein the respective first sets of attributes, the respective second sets of attributes, or both comprise a domain name system (DNS) hostname, a hostname, a network basic input/output (NetBIOS) name, a media access control (MAC) address, an internet protocol (IP) address, machine identifier, a virtual host, a virtual machine identifier, a device fingerprint, a hardware fingerprint, a subnet, a lightweight directory access protocol (LDAP) host name, elastic compute cloud instance identifier, a resource identifier associated with cloud assets, a set of services, open ports, certificate names, secure sockets layer (SSL) certificates, a set of fileshares, a set of applications, application data, operating systems, flags, penetration test configuration attributes, or any combination thereof.

19. An apparatus for network asset matching, comprising:
one or more memories storing processor-executable code; and
one or more processors coupled with the one or more memories and individually or collectively operable to execute the code to cause the apparatus to:
execute a first autonomous penetration test of a network, wherein, to execute the first autonomous penetration test, the one or more processors are individually or collectively operable to execute the code to cause the apparatus to:
gain unauthorized access to a first set of network assets of the network; and
obtain respective first sets of attributes for the first set of network assets;
execute a second autonomous penetration test of the network, wherein, to execute the second autonomous penetration test, the one or more processors are individually or collectively operable to execute the code to cause the apparatus to:
gain unauthorized access to a second set of network assets of the network; and
obtain respective second sets of attributes for the second set of network assets;
perform a network asset matching procedure to match one or more first network assets of the first set of network assets with one or more second network assets of the second set of network assets, the network asset matching procedure based at least in part on similarity scores between the respective first sets of attributes and the respective second sets of attributes;
apply a first label associated with a first network asset of the one or more first network assets to a second network asset of the one or more second network assets based at least in part on a match between the first network asset and the second network asset via the network asset matching procedure; and
output a network assessment report indicating network security information associated with the network based at least in part on the network asset matching procedure and applying the first label associated with the first network asset to the second network asset.

20. A non-transitory computer-readable medium storing code for network asset matching, the code comprising instructions executable by one or more processors to:
execute a first autonomous penetration test of a network, wherein the instructions to execute the first autonomous penetration test are executable to:
gain unauthorized access to a first set of network assets of the network; and
obtain respective first sets of attributes for the first set of network assets;
execute a second autonomous penetration test of the network, wherein the instructions to execute the second autonomous penetration test are executable to:
gain unauthorized access to a second set of network assets of the network; and
obtain respective second sets of attributes for the second set of network assets;
perform a network asset matching procedure to match one or more first network assets of the first set of network assets with one or more second network assets of the second set of network assets, the network asset matching procedure based at least in part on similarity scores between the respective first sets of attributes and the respective second sets of attributes;
apply a first label associated with a first network asset of the one or more first network assets to a second network asset of the one or more second network assets based at least in part on a match between the first network asset and the second network asset via the network asset matching procedure; and
output a network assessment report indicating network security information associated with the network based at least in part on the network asset matching procedure and application of the first label associated with the first network asset to the second network asset.
